(19) United States
(12) Patent Application Publication
(10) Pub. No.: US 2011/0261832 A1
(43) Pub. Date: Oct. 27, 2011

(54) METHOD, SYSTEM, AND APPARATUS FOR EXCHANGING INPUT AND OUTPUT DATA

(76) Inventors: Mark Anthony LoBuono, South Lyon, MI (US); Jerry Lee Simons, Northville, MI (US); Robert Anthony Rucinski, Charlottesville, VA (US); Daniel J. Bingham, Bloomfield Hills, MI (US)

(21) Appl. No.: 12/766,307

(22) Filed: Apr. 23, 2010

(51) Int. Cl. H04L 12/56

(52) U.S. Cl. 370/419

(57) ABSTRACT

A method for exchanging data using a controller includes selectively setting an exchange mode to one of a synchronous mode and an asynchronous mode, and determining whether to execute an input data exchange or an output data exchange. The input data exchange is based at least in part on an input reference that identifies an input/output (I/O) module from which the input data is retrieved, and the output data exchange is based at least in part on an output reference that identifies the I/O module to store the output data.

### BACKGROUND

The embodiments described herein relate generally to a data exchange system and, more particularly, to a system for exchanging data between system components using a communication network.

At least some known systems use serial transmissions for controlling a network of input/output (I/O) devices. Some systems use a master device that initiates a communication protocol, such as a synchronous data link control (SDLC) protocol, with the I/O devices via a serial link. In some such systems, the master device is operated either in a broadcast mode to communicate commands to the I/O devices simultaneously, or in a normal response mode to communicate commands to only desired I/O devices. Other systems use asynchronous serial transmissions for controlling a network of I/O devices by transferring data via a serial link. The data is temporarily stored in a buffer until the destination device is able to receive and process the data. However, such known systems, using either synchronous communication or asynchronous communication, require the use of a particular communication protocol, such as the SDLC protocol, that increases response times for both the master unit and the I/O devices.

### BRIEF DESCRIPTION

In one aspect, a method is provided for exchanging data over a network using a controller coupled to an interface unit having an input/output (I/O) module. The method includes selectively setting an exchange mode to one of a synchronous mode and an asynchronous mode, and determining whether to execute an input data exchange or an output data exchange. The input data exchange is based at least in part on an input reference that identifies the I/O module from which the input data is retrieved, and the output data exchange is based at least in part on an output reference that identifies the I/O module to store the output data.

In another aspect, a data exchange system includes an interface unit having at least one input/output (I/O) module, and a controller coupled to the interface unit: via a network. The controller includes a memory area and a processor coupled to the memory area. The processor is configured to selectively set an exchange mode to one of a synchronous mode or an asynchronous mode and determine whether to execute an input data exchange or an output data exchange. The input data exchange is based at least in part on an input reference that identifies the I/O module from which the input data is retrieved, and the output data exchange is based at least in part on an output reference that identifies the I/O module to store the output data.

In another aspect, a controller is coupled to an interface unit via a network. The controller includes a memory area configured to store at least one memory area location associated with an input/output (I/O) module that is coupled to the interface unit, and a processor coupled to the memory area. The processor is configured to determine whether to execute an input data exchange or an output data exchange. The input data exchange is based at least in part on an input reference that identifies the I/O module from which the input data is retrieved, and the output data exchange is based at least in part on an output reference that identifies the I/O module to store the output data.

### BRIEF DESCRIPTION OF THE DRAWINGS

The embodiments described herein may be better understood by referring to the following description in conjunction with the accompanying drawings.

FIG. 1 is a schematic block diagram of an exemplary network system.

FIGS. 2A and 2B form a flowchart that illustrates an exemplary method for exchanging data using the system shown in FIG. 1.

### DETAILED DESCRIPTION

Exemplary embodiments of methods, systems, and apparatus for use in exchanging input data and output data via a network are described herein. The embodiments described herein enable one or more networks to be used for reliable and high-performance exchange of input data and output data between a controller and one or more remote input/output (I/O) racks that include an interface unit and one or more I/O modules. The data exchange is verified and is automatically enhanced at the packet level to facilitate improved efficiency. Moreover, the embodiments described herein enable a large number, such as hundreds, of devices on one or more networks to exchange data. The devices may also be remotely located. The synchronous mode of data exchange described herein facilitates exchanging data in a precisely-controlled time domain and duration, wherein all remote I/O rack operations are synchronized to input and output scanning cycles of the controller. Such an arrangement facilitates decreasing 1/0 response times in a remote-networked I/O environment. Moreover, the remote I/O racks effectively serve as a fiber optic back plane of the controller.

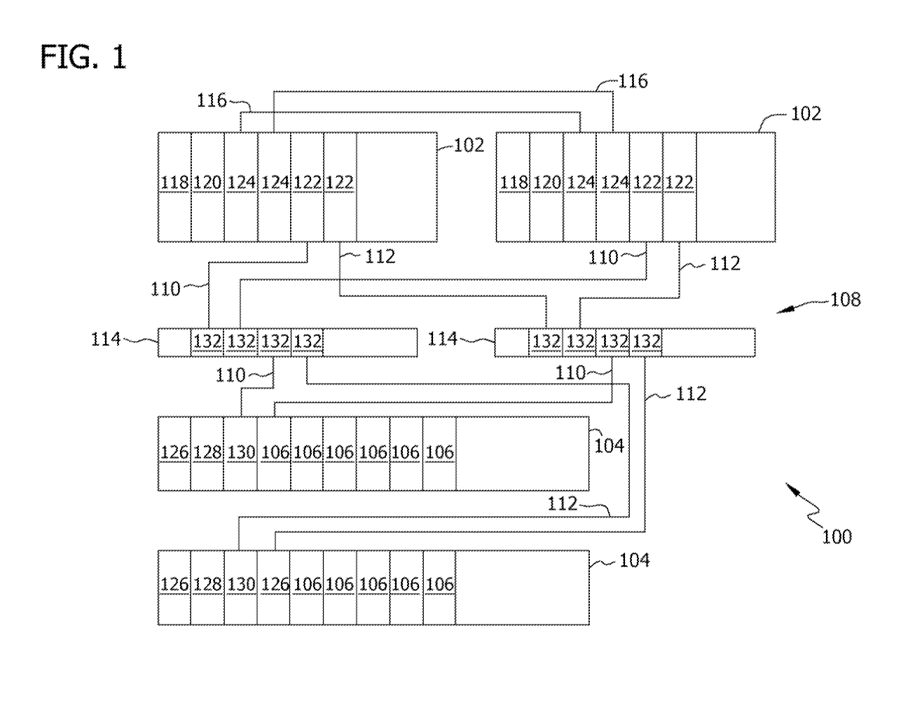

FIG. 1 is a schematic block diagram of an exemplary redundant network system 100 that may be used in, for example, an automation system or an industrial communication system to facilitate high-speed data exchanges within system 100. In the exemplary embodiment, system 100 includes a plurality of controllers 102, a plurality of interface units 104, and a plurality of I/O modules 106. In some embodiments, controllers 102 are arranged in redundant pairs with one controller 102 designated as a primary controller that controls system operation, and another controller 102 designated as a secondary or backup controller that assumes control of system 100 upon a switchover. Moreover, interface units 104 may operate alone or may operate in redundant pairs or triple arrangements. I/O modules 106 may be discrete modules, analog modules, or a mixture of discrete modules and analog modules.

Each interface unit 104 is coupled to each controller 102 via a first network 108. More specifically, system 100 includes a plurality of I/O networks 108, such as first I/O network 110 and second I/O network 112, to provide redundant communication channels between interface units 104 and controllers 102. In the exemplary embodiment, each I/O network 108 includes one or more hubs 114 that facilitate routing communication packets, including data commands, interrupts, and the like, between controllers 102 and interface units 104. In addition, each controller 102 is coupled to each remaining controller 102 via a controller network 116. More specifically, system 100 includes a plurality of controller networks 116 to provide redundant communication channels between controllers 102. In addition, controller networks 116 may be arranged in any suitable topology including, but not limited to, a star network, a ring network, or a point-to-point network. In the exemplary embodiment, I/O networks 108 and controller networks 116 are reflective memory networks. For example, in the exemplary embodiment, I/O networks 108 are fiber optic reflective memory networks that operate at approximately 2.12 Gigabaud, and allow, for example, 256 control or computer platforms to share memory with each other. In some embodiments, the control or computer platforms are capable of sharing between 16 megabytes (MB) and 256 MB of control data. Moreover, I/O networks 108 use either multi-mode or single-mode transceivers to enable communication over distances up to approximately 10 kilometers. Reflective memory networks also enable a high network data throughput rate, such as between 43 million and 174 million bytes transferred per second. Moreover, low level network packet control with reflective memory networks use, for example, 4-byte packets up to 64-byte packets to automatically enhance network throughput. Accordingly, reflective memory networks, such as I/O networks 108 provide high performance control data transfer and determinism. It will be understood that the above-described shared memory sizes, distances, and/or network capacities are exemplary only and are not intended to limit the embodiments disclosed herein.

In the exemplary embodiment, each controller 102 includes a processor 118, a memory area 120, a first network interface 112, and a second network interface 124. More specifically, each controller 102 includes an I/O network interface 122 that is dedicated to each instance of I/O network 108, and a controller network interface 124 that is dedicated to each instance of controller network 116. In an alternative embodiment, each controller 102 includes multiple processors 118. Moreover, memory area 120 may be embodied as any suitable memory device or application including, but not limited to, a database, a hard disk device, a solid state device, or any other device suitable for storing data as described herein. Furthermore, in the exemplary embodiment, memory area 120 is located within controller 102. Alternatively, memory area 120 may include any memory area internal to, external to, or accessible by controller 102. Further, memory area 120 or any of the data stored thereon may be associated with any server or other computer, local or remote from controller 102 (e.g., accessible via I/O network 108 and/or controller network 116).

In the exemplary embodiment, each interface unit 104 includes a processor 126, a memory area 128, and an I/O network interface 130 that facilitates communication with each controller 102 via I/O network 108. More specifically, in the exemplary embodiment, interface unit 104 includes an I/O network interface 130 that is dedicated to each instance of I/O network 108. In an alternative embodiment, each interface unit 104 includes multiple processors 126. Moreover, memory area 128 may be embodied as any suitable memory device or application including, but not limited to, a database, a hard disk device, a solid state device, or any other device suitable for storing data as described herein. Furthermore, in the exemplary embodiment, each hub 114 includes a dedicated I/O network interface 132 for each physical connection to I/O network 108.

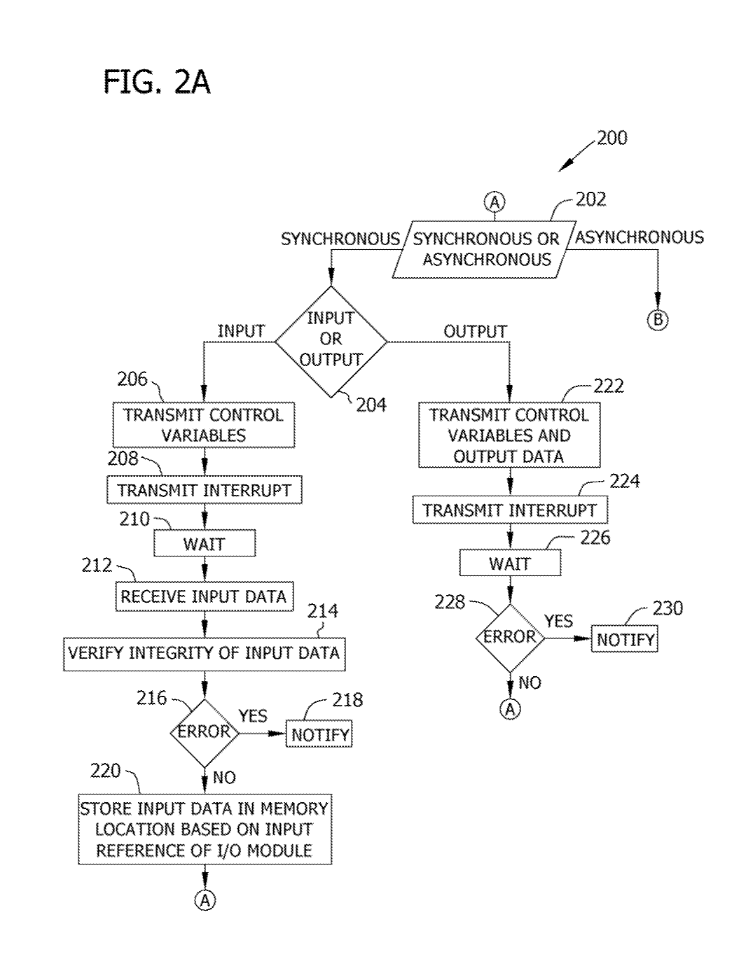

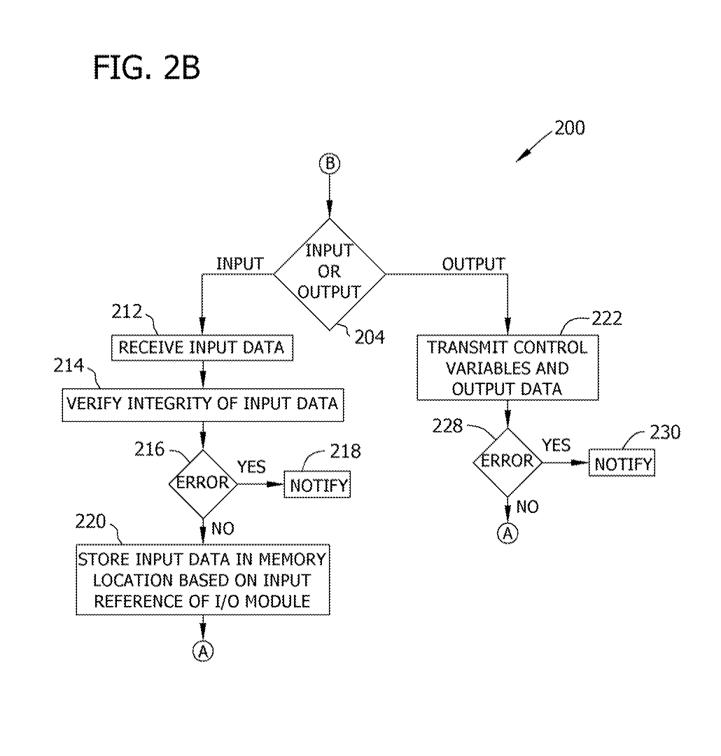

FIGS. 2A and 2B together a flowchart 200 that illustrates an exemplary method for exchanging data using system 100 (shown in FIG. 1). Referring first to FIG. 2A, and in the exemplary embodiment, an operator, for example, sets 202 an exchange mode to either a synchronous mode or an asynchronous mode. In an alternative embodiment, the exchange mode is set based on a type of data to be exchanged between controller 102 (shown in FIGS. 1) and interface unit 104 (shown in FIG. 1). In another alternative embodiment, the exchange mode is set based on, for example, a distance between controller 102 and interface unit 104. In other alternative embodiments, the exchange mode may he set on any suitable condition. In the exemplary embodiment, controller 102, flags a memory location (not shown) in memory area 120 (shown in FIG. 1) to indicate the exchange mode to be used. The synchronous mode enables collection and/or dissemination of control data, such as input data and/or output data, using a precisely-controlled, interrupt-driven time domain. Specifically, the synchronous mode enables collection and/or dissemination of control data substantially simultaneously for all interface units 104. The asynchronous mode enables collection and/or dissemination of control data without respect to time. Rather, the asynchronous mode is dependent on scan rates of controller 102 and interface units 104. In the description below, it should be noted that operations that are performed in both the synchronous mode and the asynchronous mode are referred to using the same reference characters.

In the exemplary embodiment, and when the exchange mode is set to the synchronous mode, controller 102 determines 204 whether an input data exchange or an output data exchange is necessary. For a synchronous input data exchange, controller 102 transmits 206 a plurality of control variables to interface units 104 via I/O network 108, such as via first I/O network 110 and/or second I/O network 112 (both shown in FIG. 1). In one embodiment. controller 102, via I/O network interface 122, places the control variables on I/O network 108 at the beginning of a controller scan for consumption by interface units 104. The control variables include, but are not limited to only including, digital I/O points, analog I/O points, I/O variables, and any other suitable control variables that facilitate high-speed data exchange as described herein. Controller 102 then transmits 208 a network interrupt to interface units 104 via I/O network 108. In one embodiment, the network interrupt includes a data collection command that causes at least a portion of interface units 104 to obtain data from I/O modules 106. In response to the data collection command, each interface unit 104 queries I/O modules 106 for input data, including digital input data and/or analog input data. Each interface unit 104 transmits the input data, a checksum, and control variables via I/O network 108 for consumption by controller 102. The control variables include at least an input reference that identifies, such as uniquely identifies, each I/O module 106 from which each portion of the input data was acquired.

Controller 102 waits 210 for a preselected time period to enable each interface unit 104 to complete its query of I/O modules. Controller 102 then receives 212 the input data. In one embodiment, controller 102 scans I/O network 108 to obtain the input data, the checksum, and the control variables, including the input reference of each I/O module 106. Controller 102 verifies 214 the integrity of the input data using, for example, the checksum. If an error is detected 216, controller 102 generates 218 a notification of the error by setting one or more diagnostic variables for display to an operator. If no errors are detected 216, controller 102 stores 220 the input data in memory area 116 based on the input reference of each I/O module 106. If no errors are detected, controller 102 waits until a subsequent data exchange is required.

For a synchronous output data exchange, controller 102 transmits 222 output data, a checksum, and a plurality of control variables to interface units 104 via I/O network 108, such as via first I/O network 110 and/or second I/O network 112. In one embodiment, controller 102, via I/O network interface 122, places the output data, the checksum, and the control variables on I/O network 108 at the end of a controller scan for consumption by interface units 104. Here, the control variables include, in addition to digital I/O points, analog I/O points, and/or I/O variables, at least an intended output reference and any other suitable control variables that facilitate high-speed data exchange as described herein. The output reference indicates an identity, such as a unique identity, of I/O module 106 that is to receive the output data. Controller 102 then transmits 224 a network interrupt to interface units 104 via I/O network 108. In one embodiment, the network interrupt includes a data storage command that causes at least some of interface units 104 to store data to I/O modules 106. In response to the data storage command, each interface unit 104 stores the output data I/O modules 106, including digital output data and/or analog output data. Moreover, each interface unit 104 verifies the integrity of the output data using, for example, the checksum. Controller 102 waits 226 for a preselected time period to enable each interface unit 104 to complete storage to I/O modules. If an error is detected 228, controller 102 generates 230 a notification of the error by setting one or more diagnostic variables for display to the operator. If no errors are detected 228, controller 102 waits until a subsequent data exchange is required.

Referring now to FIG. 2B, and in the exemplary embodiment, and when the exchange mode is set to the asynchronous mode, controller 102 determines 204 whether an input data exchange or an output data exchange is necessary. For an asynchronous input data exchange, each interface unit 104 queries I/O modules 106 for input data, including digital input data and/or analog input data. Controller 102 receives 212 the input data, a checksum, and control variables from each interface unit 104 via I/O network 108. In one embodiment, controller 102 scans I/O network 108 to obtain the input data, the checksum, and the control variables, including the input reference of each I/O module 106. The control variables include at least an input reference that identifies, such as uniquely identifies, each I/O module 106 from which each portion of the input data was acquired.

Controller 102 verifies 214 the integrity of the input data using, for example, the checksum. If an error is detected 216, controller 102 generates 218 a notification of the error by setting one or more diagnostic variables for display to an operator. If no errors are detected 216, controller 102 stores 220 the input data in memory area 116 based on the input reference of each I/O module 106. If no errors are detected, controller 102 waits until a subsequent data exchange is required.

For an asynchronous output data exchange, controller 102 transmits 222 output data, a checksum, and a plurality of control variables to interface units 104 via I/O network 108. In one embodiment, controller 102, via I/O network interface 122, places the output data, the checksum, and the control variables on I/O network 108 at the end of a controller scan for consumption by interface units 104. Here, the control variables include, in addition to digital I/O points, analog 1/0 points, and/or I/O variables, at least an intended output reference and any other suitable control variables that facilitate high-speed data exchange as described herein. The output reference indicates an identity, such as a unique identity, of I/O module 106 that is to receive the output data. Each interface unit 104 stores the output data I/O modules 106 at a rate that is at least partially defined by the network scan rate of each interface unit 104, wherein the output data includes digital output data and/or analog output data. Moreover, each interface unit 104 verifies the integrity of the output data using, for example, the checksum. If an error is detected 228, controller 102 generates 230 a notification of the error by setting one or more diagnostic variables for display to the operator. If no errors are detected 228, controller 102 waits until a subsequent data exchange is required.

In one embodiment, controller 102 uses the same exchange mode for each data exchange, both input and output, until the exchange mode is modified. For example, controller 102 uses the synchronous mode setting for input data exchanges and/or output data exchanges until the exchange mode is changed to the asynchronous mode. Similarly, controller 102 uses the asynchronous mode setting for input data exchanges and/or output data exchanges until the exchange mode is changed to the synchronous mode. In an alternative embodiment, the exchange mode is set for each data exchange.

Exemplary embodiments of methods, systems, and apparatus for exchanging input data and output data via a network are described above in detail. The methods, systems, and apparatus are not limited to the specific embodiments described herein but, rather, operations of the methods and/or components of the system and/or apparatus may be utilized independently and separately from other operations and/or components described herein. Further, the described operations and/or components may also be defined in, or used in combination with, other systems, methods, and/or apparatus, and are not limited to practice with only the systems, methods, and storage media as described herein.

A controller or interface unit, such as those described herein, typically includes at least some form of computer readable media. By way of example and not limitation, computer readable media include computer storage media and communication media. Computer storage media include volatile and nonvolatile, removable and non-removable media implemented in any method or technology for storage of information such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Combinations of any of the above are also included within the scope of computer readable media.

Although the present invention is described in connection with an exemplary control and/or computing system environment, embodiments of the invention are operational with numerous other general purpose or special purpose control and/or computing system environments or configurations. The control and/or computing system environment is not intended to suggest any limitation as to the scope of use or functionality of any aspect of the invention. Moreover, the control and/or computing system environment should not be interpreted as having any dependency or requirement relating to any one or combination of components illustrated in the exemplary operating environment.

Embodiments of the invention may be described in the general context of computer-executable instructions, such as program components or modules, executed by one or more computers or other devices. Aspects of the invention may be implemented with any number and organization of components or modules. For example, aspects of the invention are not limited to the specific computer-executable instructions or the specific components or modules illustrated in the figures and described herein. Alternative embodiments of the invention may include different computer-executable instructions or components having more or less functionality than illustrated and described herein.

The order of execution or performance of the operations in the embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, the term “controller” refers generally to any computer system including programmable automation controllers (PAC), programmable logic controllers (PLC), and any other computer system capable of controlling automation and/or communication functions as described herein. The above examples are exemplary only, and thus are not intended to limit in any way the definition and/or meaning of the term “controller.”

In some embodiments, the term “processor” refers generally to any programmable system including systems and microcontrollers, reduced instruction set circuits (RISC), application specific integrated circuits (ASIC), programmable logic circuits, and any other circuit or processor capable of executing the functions described herein. The above examples are exemplary only, and thus are not intended to limit in any way the definition and/or meaning of the term “processor.”

In some embodiments, the term “database” refers generally to any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

When introducing elements of aspects of the invention or embodiments thereof, the articles “a,” “an,” “the,” and “said” are intended to mean that there are one or more of the elements. The terms “comprising,” including,” and “having” are intended to be inclusive and mean that there may be additional elements other than the listed elements.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for exchanging data over a network using a controller coupled to at least one interface unit having at least one input/output (I/O) module, said method comprising:
selectively setting an exchange mode to one of a synchronous mode and an asynchronous mode; and
determining whether to execute an input data exchange or an output data exchange, the input data exchange based at least in part on at least one input reference that identifies the at least one I/O module from which the input data is retrieved, the output data exchange based at least in part on at least one output reference that identifies the at least one I/O module to store the output data.

2. A method in accordance with claim 1, further comprising exchanging input data, including:
receiving input data and the at least one input reference from the at least one interface unit via the network; and
storing the input data in a memory area location based on the at least one input reference.

3. A method in accordance with claim 2, wherein exchanging input data further comprises verifying the integrity of the input data and generating a notification upon detection of an error.

4. A method in accordance with claim 2, wherein when the exchange mode is set to the synchronous mode, exchanging input data further comprises transmitting an interrupt to the at least one interface unit via the network, the interrupt including a data collection command for execution by the at least one interface unit to retrieve the input data from the at least one I/O module according to the input reference.

5. A method in accordance with claim 1, further comprising exchanging output data, including transmitting output data and a plurality of control variables to the at least one interface unit via the network.

6. A method in accordance with claim 5, wherein exchanging output data further comprises generating a notification upon detection of a storage error.

7. A method in accordance with claim 5, wherein when the exchange mode set to the synchronous mode, exchanging output data further comprises transmitting an interrupt to the at least one interface unit via the network, the interrupt including a data storage command for execution by the at least one interface unit to store the output data on the at least one I/O module according to the at least one output reference.

8. A data exchange system comprising:
at least one interface unit comprising at least one input/output (I/O) module; and
a controller coupled to said at least one interface unit via a network, said controller comprising a memory area and a processor coupled to said memory area, said processor configured to:
selectively set an exchange mode to one of a synchronous mode and an asynchronous mode; and
determine whether to execute an input data exchange or an output data exchange, the input data exchange based at least in part on at least one input reference that identifies said at least one I/O module from which the input data is retrieved, the output data exchange based at least in part on at least one output reference that identifies said at least one I/O module to store the output data.

9. A data exchange system in accordance with claim 8, wherein, when executing the input data exchange, said processor further configured to:
receive input data and the at least one input reference from said at least one interface unit via said network; and
store the input data in a location of said memory area based on the at least one input reference.

10. A data exchange system in accordance with claim 9, wherein, when executing the input data exchange, said processor is further configured to verify the data integrity of the input data and generate a notification upon detection of an error.

11. A data exchange system in accordance with claim 9, wherein, when executing the input data exchange with the exchange mode set to the synchronous mode, said processor is further configured to transmit an interrupt to said at least one interface unit via said network, the interrupt including a data collection command for execution by said at least one interface unit to retrieve the input data from said at least one I/O module according to the at least one input reference.

12. A data exchange system in accordance with claim 8, wherein, when executing the output data exchange, said processor further configured to transmit output data and a plurality of control variables.

13. A data exchange system in accordance with claim 12, wherein, when executing the output data exchange, said processor is further configured to generate a notification upon detection of a storage error.

14. A data exchange system in accordance with claim 12, wherein, when executing the output data exchange with the exchange mode set to the synchronous mode, said processor is further configured to transmit an interrupt to said at least one interface unit via said network, the interrupt including a data storage command for execution by said at least one interface unit to store the output data on said at least one I/O module according to the at least one output reference.

15. A controller coupled to an interface unit via a network, said controller comprising:
a memory area configured to store at least one memory area location associated with an input/output (I/O) module that is coupled to the interface unit; and
a processor coupled to said memory area, said processor configured to determine whether to execute an input data exchange or an output data exchange, the input data exchange based at least in part on an input reference that identifies the I/O module from which the input data is retrieved, the output data exchange based at least in part on an output reference that identifies the I/O module to store the output data.

16. A controller in accordance with claim 15, wherein said processor is configured to selectively set an exchange mode to one of a synchronous mode and an asynchronous mode.

17. A controller in accordance with claim 16, wherein, when executing the input data exchange, said processor further configured to:
receive input data and an input reference from the interface unit via the network; and
store the input data in the at least one memory area location based on the input reference.

18. A controller in accordance with claim 17, wherein for the input data exchange and with the exchange mode set to the synchronous mode, said processor is further configured to transmit an interrupt to the interface unit via the network, the interrupt including a data collection command for execution by the interface unit to retrieve the input data from the I/O module according to the input reference.

19. A controller in accordance with claim 16, wherein, when executing the output data exchange, said processor further configured to transmit output data and a plurality of control variables.

20. A controller in accordance with claim 19, wherein for the output data exchange and with the exchange mode set to the synchronous mode, said processor is further configured to transmit an interrupt to the interface unit via the network, the interrupt including a data storage command for execution by the interface unit to store the output data on the I/O module according to the output reference.
